(19) United States
(12) Patent Application Publication
(10) Pub. No.: US 2003/0054680 A1
(43) Pub. Date: Mar. 20, 2003

(54) Assemly for an outlet

(76) Inventor: Lorne Ross, Toronto (CA)

Correspondence Address: Oliff & Berridge, PO Box 19928, Alexandria, VA, 22320, US

(21) Appl. No.: 10/203,835

(22) PCT Filed: Feb. 15, 2001
(86) PCT No.: PCT/CA01/00186

(51) Int. Cl. H01R 13/44

(52) U.S. Cl. 439/131

(57) ABSTRACT

A pivoting outlet, for electrical and other services, that can be installed in various surfaces such as desktops or similar furniture, drywalls, and outside walls of buildings. The structure pivotally mounts an outlet bracket with a slot for an outlet providing one or more services. A terminal block is included to interconnect the outlet to various sources for the services. The outlet bracket is pivotally rotated between a working and a recessed position. Further, a door, a door tab, a cord guide, and a cord bracket are integrated with the outlet bracket. The cord guide is designed to allow various devices to be connected to the outlet even with the outlet bracket in the recessed position. The cord bracket may be used to secure the cords of the various devices. The combination of these features has a number of advantages including cord strain relief, aesthetics, and weather protection.

### TECHNICAL FIELD

The invention relates in general to outlets and, more particularly, to an assembly for electrical, data, optical, BNC outlets or connectors.

### BACKGROUND ART

Most electrical devices have a cord with a plug to connect to a receptacle for a source of electrical power. Until recent times, usually one source and therefore only one connection was required. However, in recent times, technological progress has resulted in an increasing number of useful devices that require connection to a host of other sources or devices to function properly. These other sources or devices, herein referred to as “services”, may include electrical power supplies, networks whether data or multi media, telephone lines, and communication networks. The multiplicity of different services has also resulted in a multiplicity of different receptacles or outlets. Further, these services have to be provided in a number of very different environments including the office, home, factory and outdoors.

While providing a range of different services, the receptacles or outlets are further required to satisfy a number of requirements including case of replacement for a different set of receptacles, ease of use, aesthetics, weather proofing, and wire or cord strain relief. There are a number of different outlet designs, but they are not able to satisfactorily meet all these requirements. They include recessed receptacles with a cover, temporary power/data taps, retractable power centers, and rotatable receptacles.

It is desirable to have an assembly with an outlet which can be easily replaced to provide a different number of receptacles for different services even after the assembly has been installed; that allows users to easily connect and disconnect the plugs; that allows a door for a greater aesthetic appearances even when in use; that allows for weather proofing if necessary; and that provides strain relief for the cords of the various devices.

### SUMMARY OF THE INVENTION

In accordance with an aspect of the invention, the assembly for an outlet, where the outlet has a working face, comprises a structure defining a surface having an opening; an outlet bracket adapted to support the outlet and mounted to the structure for movement between a working position in which the working face is presented within the opening, and a recessed position in which a volume adjacent to the working face is available for component storage; and a door movable between an opened position for permitting access to the opening and a closed position for closing the opening.

In accordance with another aspect of the invention, a cord bracket is attached to the outlet bracket and which projects into a volume inside the assembly when the outlet bracket is in the recessed position. The cord bracket can be integral with the outlet bracket.

Therefore, the invention disclosed herein has certain advantages including an outlet which can be easily replaced to provide a different number of receptacles for different services even after the assembly has been installed; allowing users to easily connect and disconnect the plugs; allowing the assembly to be covered by a door for a greater aesthetic appearances even during use; allowing for weather proofing if necessary; and providing strain relief for the cords of the various devices.

Other and further advantages and features of the inventions will be apparent to those skilled in the art from the following detailed description thereof.

In accordance with another aspect of the present invention, there is provided an assembly for an outlet, the outlet having a working face, the assembly comprising:

a structure defining a surface having an opening;

an outlet bracket adapted to support the outlet and mounted to the structure for movement between a working position in which the working face is presented within the opening, and a recessed position in which a volume adjacent to the working face is available for component storage; and

a cord bracket, mounted on the outlet bracket and which projects into the volume when the outlet bracket is in the recessed position, for a cord to wrap around in order to provide strain relief and to prevent a plug attached to the cord from being accidentally pulled out of the outlet.

In accordance with another aspect of the present invention, there is provided an assembly for an outlet, the outlet having a working face, the assembly comprising:

a structure defining a surface having an opening;

an outlet bracket adapted to support the outlet and mounted to the structure for movement between a working position in which the working face is presented within the opening, and a recessed position in which a volume adjacent to the working face is available for component storage;

a door connected to the outlet bracket;

a cord guide which is integral with at least one of the door and the structure for passage of a wire when the outlet bracket is in the recessed position;

at least one detent mechanism mounted on the outlet bracket and the structure for holding the outlet bracket in the recessed position; and

a cord bracket, mounted on the outlet bracket and which projects into the volume when the outlet bracket is in the recessed position, for a cord to wrap around in order to provide strain relief and to prevent a plug attached to cord from being accidentally pulled out of the outlet.

### BRIEF DESCRIPTION OF THE DRAWINGS

The present invention will be described in detail with reference to the accompanying drawings, in which like numerals denote like parts in the several views, and in which:

FIG. 1 is a partial sectional perspective view of the assembly for an outlet where the outlet is partially open;

FIG. 2 is a sectional view of the assembly for an outlet where the outlet is in the closed or recessed position;

FIG. 3 a perspective view of an alternate embodiment of the assembly for an outlet where the outlet is in the working or opened position;

FIG. 4 a perspective view of another alternate embodiment of the assembly with a number of different types of receptacles in the working or opened position; and

FIG. 5 is a partial exploded perspective view of another alternate embodiment of the assembly where the outlet bracket is on a slide mounting instead of a pivot mounting.

### DETAILED DESCRIPTION OF THE PREFERRED EMBODIMENTS

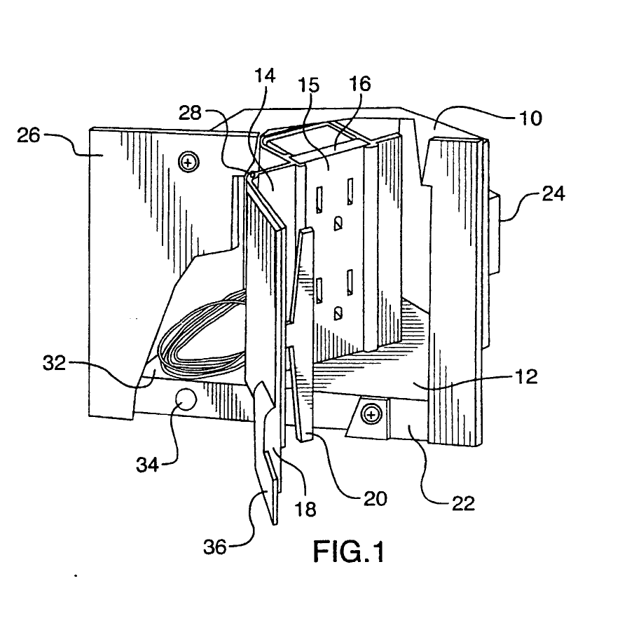

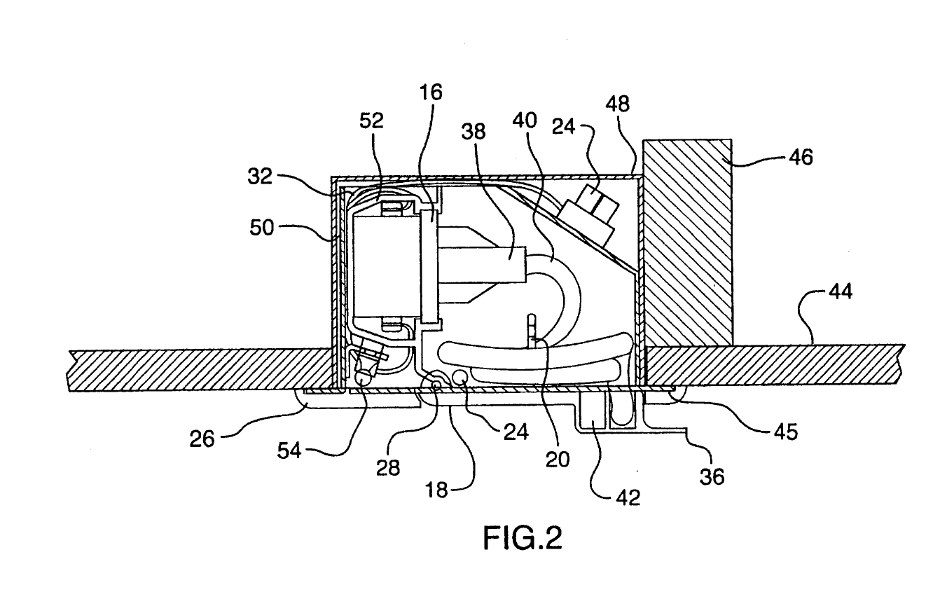

Referring now to the drawings, FIGS. 1 and 2 illustrate a preferred embodiment of an assembly for an outlet for electrical power.

The assembly is designed to be a modular unit for ease of installation into a drywall 44 adjacent to a wall stud 46. It has clearance holes 34 for mounting screws. The assembly includes a structure 10, an outlet bracket 14, an outlet 16, a door 18, a cord bracket 20, and a terminal block 24. The structure 10 is composed of a standard metal double-gang junction box 48 and an outlet assembly housing 50. The terminal block 24 is attached to the back of the structure 10 in an out-of-the-way location on the outlet assembly housing 50. The electrical power wire (not shown) passes through a hole (not shown) in the junction box 48 and connects (not shown) to the terminal block 24. The terminal block 24 is further connected to the outlet 16 by connect wire 32 for delivering electrical power to the outlet 16. The connect wire 32 is of sufficient length to allow the full travel of the outlet bracket 14 from the working position to the recessed position.

The outlet bracket 14 is pivotally mounted across an edge of the opening 12 of the structure 10 by a pivot pin 28. A detent mechanism 54 is attached to the outlet bracket 14 and the structure 10 to hold the outlet bracket 14 in the recessed position and to provide an initial resistance to the movement of the outlet bracket 14 from the recessed position to the working position. The detent mechanism 54 is a standard externally threaded ball stud, which is attached to the outlet bracket 14, and a corresponding bracket to capture the ball, which is attached to the structure 10. An outlet bracket open stop 21 is attached to structure 10 to stop the outlet bracket 14 from rotating past the working position.

The outlet bracket 14 has a slide mounting 52 on one side of the pivoting axis of the pivot pin 28, and the door 18 and cord bracket 20 on the other side. The door 18 is integral with the outlet bracket 14. The cord bracket 20 is attached to the outlet bracket 14 adjacent to the working face 15 of the outlet 16 and projects into the structure 10 when the outlet bracket 14 is in the recessed position. The shape of the slide mounting 52 is designed to allow a standard electrical outlet to be slid into the mounting. A cord guide 42 is integral with the door 18 and includes a power cord channel 22 on the structure 10. A door tab 36 is also integral with the door 18 to assist with opening the outlet bracket 14 and overcoming the resistance of the detent mechanism 54.

In this embodiment, the working position coincides with the opened position, the recessed position coincides with the closed position, and the outlet bracket 14 and the door have a common axis of rotation. A plastic bezel 26 covers the front surface 45 and the door 18. The colouring, texture and style of the plastic bezel 26 can be chosen to match the surrounding decor.

The assembly can be used in both the working and recessed positions. A plug 38 can be connected to and used with the outlet 16 in the working position. A cord 40 can also be wrapped around the cord bracket 20 to provide strain relief and to prevent the plug 38 from being accidentally and forcibly pulled out. The outlet bracket 14 and the door 18 can be closed or moved to the recessed position with the plug 38 connected to the outlet 16. The cord 40 can pass through the door 18 via the cord guide 42. FIG. 2 illustrates a plug 38 and cord 40 connected to the outlet 16 in the recessed position.

In the recessed position, with the cord 40 wrapped around the cord bracket 20, further cord strain relief is provided as any pulling force on the cord 40 would have to overcome the resistance of the detent mechanism and the force needed to rotate the outlet bracket 14.

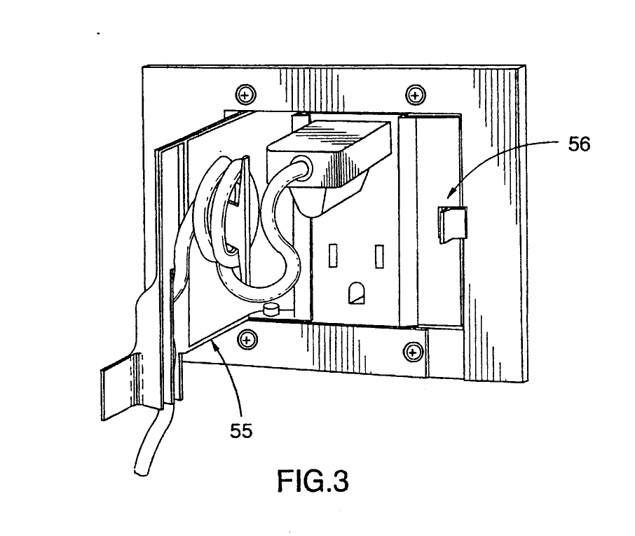

In a further alternate embodiment, FIG. 3 illustrates a latch 56 as an additional means to hold the door 55 in the closed or recessed position.

In a further alternate embodiment, another detent mechanism has been added to the above embodiments to hold the outlet bracket in the working position as well as preventing such from rotating past the working position.

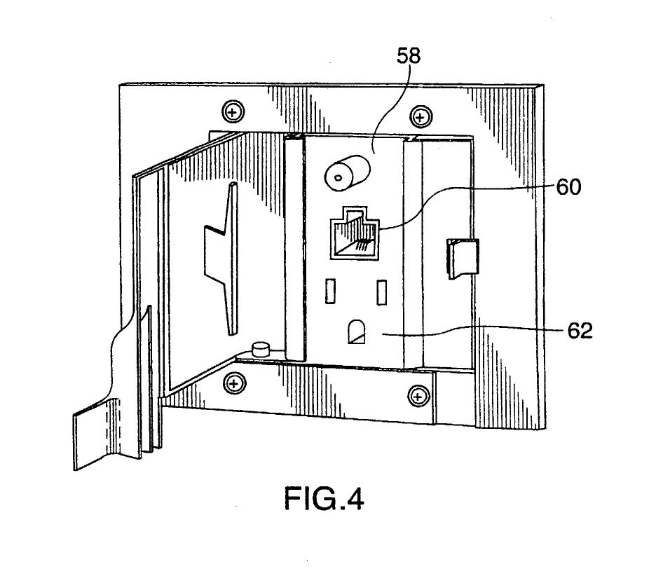

FIG. 4 illustrates a further application, the outlet provides a number of different receptacles as provided by an electrical socket 62, co-axial cable port 58, and RJ11 port 60 for various services like electricity, data, communications, video, and entertainment.

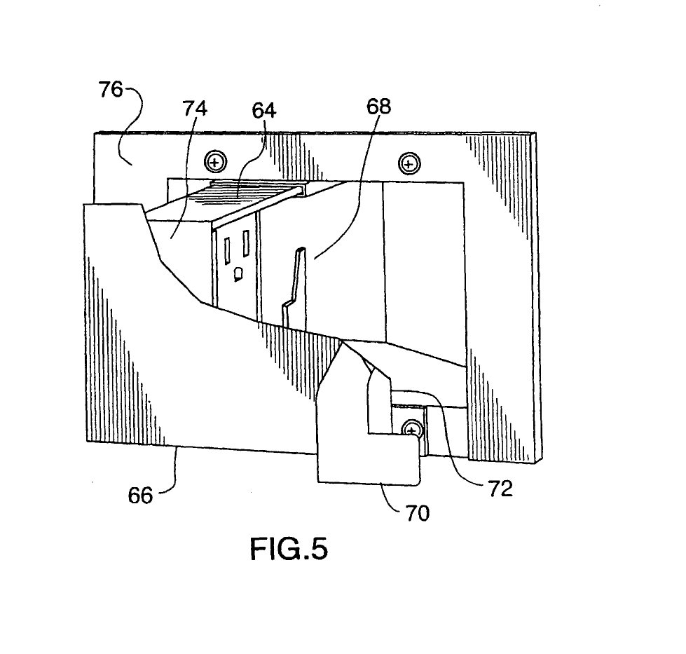

FIG. 5 illustrates a further alternate embodiment where the outlet bracket is slide mounted to the structure 76 on bracket slide 64 instead of being pivotally mounted to the structure 76. The assembly can be slid into or out of a wall or other structure. The door 66, cord bracket 68, door tab 70, and cord guide 72 are affixed to the outlet bracket 74.

Although alternate embodiments of the invention have been described herein, it will be understood by those skilled in the art that variations may be made thereto without departing from the spirit of the invention or the scope of the appended claims.

1. An assembly for an outlet, the outlet having a working face, the assembly comprising:
a structure defining a surface having an opening;
an outlet bracket adapted to support the outlet and mounted to the structure for movement between a working position in which the working face is presented within the opening, and a recessed position in which a volume adjacent to the working face is available for component storage; and
a cord bracket, mounted on the outlet bracket and which projects into the volume when the outlet bracket is in the recessed position, for a cord to wrap around in order to provide strain relief and to prevent a plug attached to the cord from being accidentally pulled out of the outlet.

2. The assembly of claim 1, further comprising a door connected to the outlet bracket.

3. The assembly of claim 2, further comprising a cord guide which is integral with at least one of the door and the structure for passage of a wire when the outlet bracket is in the recessed position.

4. The assembly of claim 1, further comprising at least one detent mechanism mounted on the outlet bracket and the structure for holding the outlet bracket in the recessed position.

5. The assembly of claim 1, further comprising at least one detent mechanism mounted on the outlet bracket and the structure for holding the outlet bracket in the working position.

6. The assembly of claim 1, further comprising at least one terminal block for connecting the outlet to at least one source.

7. The assembly of claim 6, wherein the terminal block is attached to the structure.

8. The assembly of claim 1, wherein the outlet bracket has a slide mounting for holding the outlet.

9. The assembly of claim 1, wherein the outlet has at least one of electrical outlet, data port, communications port, video port, and entertainment port.

10. The assembly of claim 1, wherein the cord bracket has a T shape.

11. An assembly for an outlet, the outlet having a working face, the assembly comprising:
a structure defining a surface having an opening;
an outlet bracket adapted to support the outlet and mounted to the structure for movement between a working position in which the working face is presented within the opening, and a recessed position in which a volume adjacent to the working face is available for component storage;
a door connected to the outlet bracket;
a cord guide which is integral with at least one of the door and the structure for passage of a wire when the outlet bracket is in the recessed position;
at least one detent mechanism mounted on the outlet bracket and the structure for holding the outlet bracket in the recessed position; and
a cord bracket, mounted on the outlet bracket and which projects into the volume when the outlet bracket is in the recessed position, for a cord to wrap around in order to provide strain relief and to prevent a plug attached to cord from being accidentally pulled out of the outlet.

12. The assembly of claim 11, further comprising at least one detent mechanism mounted on the outlet bracket and the structure for holding the outlet bracket in the working position.

13. The assembly of claim 11, further comprising at least one terminal block for connecting the outlet to at least one source.

14. The assembly of claim 11, wherein the terminal block is attached to the structure.

15. The assembly of claim 11, wherein the outlet bracket has a slide mounting for holding the outlet.

16. The assembly of claim 11, wherein the outlet has at least one of electrical outlet, data port, communications port, video port, and entertainment port.
